(19) United States
(12) Patent Application Publication
(10) Pub. No.: US 2005/0133958 A1
(43) Pub. Date: Jun. 23, 2005

(54) System and method for coloring a spray urethane skin for vehicle interior trim components and skins made thereby

(75) Inventors: Andrew P. Mellentine, Owosso, MI (US); Joseph T. Donatti, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/745,064

(22) Filed: Dec. 22, 2003

(51) Int. Cl. B29C 41/08; B29C 41/22

(52) U.S. Cl. 264/245; 264/331.19; 264/255; 425/96

(57) ABSTRACT

A system and method of making polyurethane skins for interior components is provided. In at least one embodiment, the method comprises providing at least one liquid colorant source, providing a polyol source, providing an isocyanate source, providing a spraying device and providing a mixing chamber between the polyol source and the spraying device. The method further comprises introducing a stream of polyol from the polyol source and a stream of colorant from the colorant source into the mixing device to form a stream of colorant/polyol, introducing the stream of colorant/polyol and a stream of isocyanate from the isocyanate source into the spraying device to form a colored polyurethane composition, and spraying the colored polyurethane composition onto a mold to form a first colored polyurethane skin.

### BACKGROUND OF THE INVENTION

1. Field of the Invention

The present invention relates to spray formed polyurethane skins for vehicle interior trim components and method and systems for manufacturing such skins.

2. Background Art

Skins for interior trim components provide a durable plastic cover for interior trim component structures and their associated foam padding. Vinyl skins for interior trim components of a vehicle are made by rotocasting a liquid vinyl composition in a heated mold as it is rotated. It has been proposed and implemented in production processes to add liquid color concentrates into the liquid vinyl composition that is provided to rotational molds in rotational molding operations for armrests and small trim components. Vinyl rotocasting processes are labor intensive and are difficult to control and can result in parts having substantial variations in skin thickness. Vinyl skins are not readily recycled and tend to harden over time that may lead to splits in the skin surface over the life of the vehicle. Vinyl skins are also very sensitive to staining when in contact with polyurethanes and exposed to heat and ultraviolet light from the sun.

Recently, substantial efforts have been made to develop polyurethane skins for interior trim components. Polyurethane skins may be sprayed in a robotic spraying process that may be computer controlled to obtain uniform skin thickness. Aromatic polyurethane compositions are generally black or gray in color but may also be untinted resulting in an amber color. Aliphatic polyurethane compositions may be provided in many different colors. To assure precise color matching to a vehicle interior component, an in-mold coating is preferably applied to the polyurethane skin forming mold prior to spraying the polyurethane composition over the in-mold coating and onto the mold surface. Examples of interior components that may be made by the polyurethane spray forming operation include instrument panels, glove box doors, knee bolsters, door panels and other interior trim components.

Some vehicle interior components have complex shapes and may include difficult to access areas. For example, instrument panel brows may include a narrow section that cannot be easily and completely coated with an in-mold coating composition. Excessive in-mold coating material that may be applied to the surface of the material is wasted and may form runs or irregularities that can adversely effect part quality. In difficult to access areas, such as sharp radii and undercuts, gaps in the in-mold coating may be formed through which the polyurethane skin material may be visible. Moreover, with normal vehicle use and/or during the manufacturing process, scratching or marring in the in-mold coating may occur through which the polyurethane skin may be visible. If so, it may be necessary to paint the skins after forming in areas where there polyurethane skin is visible through the in-mold coating. Such post painting operations are labor intensive, may not produce the same color and gloss level, and require additional capital investment for post painting operation stations.

There is a need for a flexible and cost effective method of spray forming polyurethane parts with a continuous and complete color even where an in-mold coating is present having gaps or areas of inadequate coverage.

The above problems and needs are addressed by applicant's invention as summarized below.

### SUMMARY OF THE INVENTION

According to at least one embodiment of the present invention, a method of making polyurethane skins for interior components is provided. The method comprises providing at least one liquid colorant source, providing a polyol source, providing an isocyanate source, providing a spraying device and providing a mixing chamber between the polyol source and the spraying device. The method further comprises introducing a stream of polyol from the polyol source and a stream of colorant from the colorant source into the mixing device to form a stream of colorant/polyol, introducing the stream of colorant/polyol and a stream of isocyanate from the isocyanate source into the spraying device to form a colored polyurethane composition, and spraying the colored polyurethane composition onto a mold to form a first colored polyurethane skin.

In a further embodiment of the method, a flush source is provided. The method further comprises providing a stream of flushant from the flush source to the spraying device to flush the spraying device, and, after flushing the spraying device, providing a second stream of colorant/polyol and a second stream of isocyanate to the spraying device to form a second colored polyurethane skin.

According to certain aspects of the present invention, the second colored polyurethane skin is a different color than the first colored polyurethane skin.

In certain other embodiments, the second colored polyurethane skin is the same color as the first colored polyurethane skin.

In at least one embodiment of the method, the at least one colorant source comprises a plurality of colorant sources.

According to another embodiment of the present invention, a system for manufacturing polyurethane skins for interior components is provided. The system comprises a source of at least one liquid colorant, a source of polyol, a source of isocyanate, a mixing chamber for mixing polyol with at least one colorant to form a colorant/polyol stream, a spraying device for spraying a mixture of isocyanate and colorant/polyol, and a mold having a mold surface toward which a mixture of isocyanate and colorant/polyol are sprayed by the spraying device onto the mold.

In a further embodiment of the system, the system further comprising providing a flush source for providing a stream of flushant to flush the spraying device.

In at least one embodiment, the mixing device includes a helical mixing element.

These and other aspects of the present invention will be readily understood by one of ordinary skill in the art in view of the attached drawings and following detailed description of the preferred embodiments of the present invention.

### BRIEF DESCRIPTION OF THE DRAWINGS

FIG. 1 is a schematic elevation view, partially in section, of one embodiment of a spray applicator assembly;

FIG. 2 is a cross-sectional view taken along the line 2-2 in FIG. 1;

FIGS. 3 and 4 are cross-sectional views taken along the line 3-3 in FIG. 1 showing the mix head with the metering rod in a recirculating and in a dispensing position, respectively;

FIG. 5 is a fragmentary perspective view of a polyurethane skin having a partial in-mold coating with a portion of the polyurethane skin visible through the in-mold coating.

### DETAILED DESCRIPTION OF THE PREFERRED EMBODIMENTS

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of”, and ratio values are by weight and the description of a group or class of materials as suitable or preferred for a given purpose in connection with the invention implies that mixtures of any two or more members of the group or class may be equally suitable or preferred.

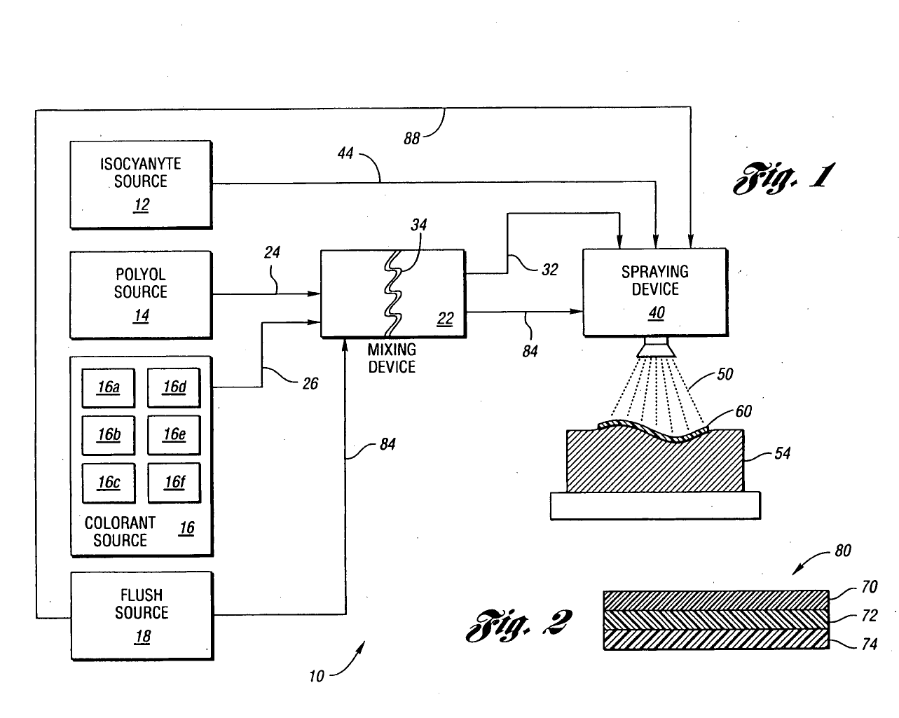

Referring now to FIG. 1, a system 10 for spray forming polyurethane skins for vehicle interior trim components is schematically illustrated. A liquid isocyanate source 12 is provided. Any suitable liquid isocyanate, such as an aromatic isocyanate, can be used. Examples of suitable aromatic liquid isocyanates include, but are not necessarily limited to, MDI and TDI. Alternatively, liquid aliphatic isocyanate could also be used. The liquid isocyanate could have suitable additives, such as UV inhibitors/stabilizers. Suitable suppliers of suitable liquid isocyanates include Huntsman of Auburn Hills, Mich.; Bayer Polymers of Pittsburgh, Pa.; and Dow Chemical of Freeport, Tex.

A liquid polyol source 14 is provided. Any suitable liquid polyol can be used. In at least one embodiment, the polyol employed is a polyether polyol. Examples of suitable liquid polyols include, but are not necessarily limited to, graft polyols, PhD polyols, Polymer Polyols, and PIPA polyols. Suitable suppliers of suitable liquid polyols include Dow Chemical of Freeport, Tex.; BASF Corporation of Wyandotte, Mich.; and Bayer Polymer of Pittsburgh, Pa. The liquid polyol could have suitable additives, such as UV and antioxidant inhibitors/stabilizers, such as Irganox 1175, Tinuvin 765 and TIN B-75, from Ciba Specialty Chemicals of Terrytown, N.Y., and Cyasorb® Family UV stabilizers and antioxidants from Cytec Polymers of Stamford, Conn.

At least one liquid colorant source 16 is provided. As shown, the liquid colorant source 16 could include more than one individual sources 16a-f of color. In other words, a plurality of individual liquid colorant sources, 16a-f, each containing a different color, such as red, blue, black, etc, could be provided. Any suitable liquid colorant can be used. Examples of suitable liquid colorants include, but are not necessarily limited to, finely ground pigment dispersed in a liquid component useable in the formation of polyurethane, such as polyol and/or isocyanate. Other suitable colorants, such as liquid dyes, can also be used. Suppliers of suitable colorants include Rite Systems of West Chicago, Ill. and PolyOne of North Baltimore, Ohio. In certain embodiments, the liquid colorant includes a UV stabilizer, such as zinc, benzophones, benzotriazole, and benzoxazione to inhibit UV degradation should the resultant polyurethane skin be exposed to UV light. Other suitable additives could be included, such as, but not necessarily limited to, triazines and radical scavengers, as are available from Ciba Specialty Chemicals and Cytec Polymers.

A solvent flush source 18 is provided. Any suitable liquid solvent flush can be used. Suitable solvent flushes include solvents that do not react with the isocyanate and polyol. Examples of suitable liquid solvent flushes include, but are not necessarily limited to MEK (methyl ethyl ketone), DBE (dibasic ester), NMP (Naptha) and mineral spirts, as are available from Ashland Chemical of Dublin, Ohio and Shell Oil Solvents of Kent, Ohio.

A mixing device 22 is provided. The mixing device 22 receives a stream 24 of polyol and a stream 26 of colorant from the polyol source 14 and the colorant source 18, respectively. In the mixing device 22, the polyol and the colorant mix to form a colorant/polyol stream 32. In a preferred embodiment, the mixing device includes a helical mixing element 34 that promotes mixing in the mixing device 22.

A spraying device 40, such as a conventional spray gun, is provided. The spraying device 40 receives the colorant/polyol stream 32 and an isocyanate stream 44 from the mixing device 22 and the isocyanate source 12, respectively. The streams 32 and 44 mix in the mixing device 40 to form a liquid polyurethane composition which is sprayed from the spraying device 40 in the form of an aromatic polyurethane stream 50. In at least one embodiment, the polyurethane composition is an aromatic composition. The polyurethane stream 50 is directed towards a spray mold 54 to form a colored polyurethane layer 60, when dried. In at least one embodiment, the polyurethane layer 60 is aromatic.

In at least one embodiment, a second polyol stream (not shown) can be fed to the spray device 40 such that the polyurethane composition is formed by a mixture of the colorant/polyol stream 32, the isocyanate stream 44 and the second polyol stream. In certain embodiments, the second polyol stream (not shown) can be mixed with a colorant in a similar manner as used to form the colorant/polyol stream 32. In this embodiment, the colorant in the second polyol stream (not shown) can be the same or different than the colorant in the colorant/polyol stream 32.

In at least one embodiment, the polyol, isocyanate and the colorants are maintained at elevated temperatures. In certain embodiments, the elevated temperatures are each independently 70-125° F., and in other embodiments 75-95° F. These elevated temperatures can be maintained withing the sources 12, 14 and 16, the streams 24, 26 and 44, the mixing device 22 and the spray device 40. Each of the streams 32 and 44 may be provided at a pressure of between 600 psi and 2,000 psi to the spray device 40.

In at least one embodiment, the colorant (i.e., dye or pigment) is provided in an amount of 1-20 wt. %, based on the total weight of the colorant/polyol stream 32, and in other embodiments an amount of 3-10 wt. %, based on the total weight of the colorant/polyol stream 32. In certain embodiments, the colorant is provided in an amount of 0.5-15 wt. %, based on the total weight of the polyurethane stream 50, and in other embodiments an amount of 1-8 wt. %, based on the total weight of the polyurethane stream 50.

In at least one embodiment of the present invention, the colored polyurethane layer 60 is made by first mixing a stream of polyol 24 with at least one stream of a colorant 26 in the mixing device 22 to form a stream of colorant/polyol 32. In forming the stream of colorant/polyol 32, the appropriate colorant 16a-16f is selected to mix with the stream of polyol 24, depending upon the desired color of the colored polyurethane layer 60. For instance, if the colored polyurethane layer 60 is desired to be blue, a stream of blue colorant (26) is sent to the mixing device 22 from the colorant source 16. In at least one embodiment, a processor (CPU) can be provided to control the operation. The stream of colorant/polyol 32 is then mixed with the isocyanate stream 44 in the spray device 40 to form a colored polyurethane composition which is sprayed from the spraying device 40 in the form of a colored polyurethane stream 50 towards the spray mold 54 to form the colored polyurethane layer 60 of the desired color. In at least one embodiment, after each polyurethane layer 60 is formed, a solvent flush stream 84 is sent from the flush source 18, through the mixing device 22, and through the spray device 40 to clean the isocyanate, polyol and colorant from the mixing device 22 and the spray device 40 to prevent clogging of the equipment and/or undesired color mixing. In some embodiments, such as when consecutive runs of the same color polyurethane stream 50 is being used, a flush stream 88 is sent from the flush source 18 directly to the spray device 40, primarily to prevent clogging. During the flushing step, the spray device 40 delivers a stream of flushant (not shown) into a waste receptacle (not shown) such as a waste bucket. After the spray device 40 has been flushed, the process can be repeated to form a colored polyurethane layer 60 of a desired color. This process allows the selective control of the colored polyurethane layer 60. For instance, a different color could be selected for each successive colored polyurethane layer 60 that is being manufactured. Alternatively, the same color could be used for long production runs of the colored polyurethane layer 60. In this case, flush stream 88 could be used. In certain embodiments, however, it may be desired to use both flush streams 84 and 88.

In at least one embodiment, the spray device 40 could be such that the colorant/polyol stream 32 and the isocyanate stream 44 mix outside of the spray device 40 but before reaching the spray mold 54. In this embodiment, three streams could be exiting the spray device 40 directed at each other to uniformly mix prior to contacting the spray mold 54. The three streams would be the colorant/polyol stream 32, the isocyanate stream 44, and a second polyol stream (not shown) which could either be straight polyol or a mixture of colorant and polyol.

In at least one embodiment, the system and the method of the present invention is employed to form a polyurethane skin 70. In certain embodiments, the polyurethane skin 70 comprises only the colored polyurethane layer 60. In certain other embodiments, the polyurethane skin 70 comprises the colored polyurethane layer 60 and an in-mold coating (not shown) or paint layer (not shown) disposed over the polyurethane layer 60. In at least one embodiment, when an in-mold coating (not shown) or paint layer (not shown) are provided, they are the same or similar color as the colored polyurethane layer 60. In other embodiments, the polyurethane layer 60 is 80% to 95% color matched to the outer IMC or paint layer color with a ΔE of less than 3.0 and gloss level between 1.0 and 10.

The polyurethane skin 70 can form a portion of a trim product 80, such as an instrument panel, glove box door, knee bolster, door panel and other interior trim component. In at least one embodiment, the trim panel 80 comprises the polyurethane skin 70 disposed over a foam layer 72 which is disposed over a substrate 74, such an ABS substrate. In at least one embodiment, the colored polyurethane skin 70 is removed from the mold 54 and put in a forming tool (not shown) with, but spaced from, substrate 74 to allow foam layer 72 to form therebetween.

When the polyurethane skin 70 comprises an in-mold coating (not shown) or paint layer (not shown), the colored layer 60 and the trim panel 80 may have restricted access areas that correspond to areas of the mold 54 that are difficult to reach such as the brow portion of an instrument panel cover. In these instances, gaps in the in-mold coating may be found in restricted access areas and/or scratches may occur at some time during the use to form gaps. When gaps are formed, the colored polyurethane layer 60 may be visible in the gaps. In these instances, the colored polyurethane layer 60 reduces the visibility of any color differential between the colored polyurethane layer 60 and the in-mold coating (not shown) or paint layer (not shown). Also, the colored polyurethane layer 60 makes it possible to have an aesthetic outer appearance without the use of an in-mold coating (not shown) or paint layer (not shown).

While embodiments of the invention have been illustrated and described, it is not intended that these embodiments illustrate and describe all possible forms of the invention. Furthermore, the omission or schematic illustration of conventional equipment, such as pumps, valves, heaters, etc., should not be interpreted as certain convention equipment not being needed or present in the system or as limiting the invention in any manner. Rather, the words used in the specification are words of description rather than limitation, and it is understood that various changes may be made without departing from the spirit and scope of the invention.

1. A method of making polyurethane skins for interior components, said method comprising:
providing at least one liquid colorant source;
providing a polyol source;
providing an isocyanate source;
providing a spraying device;
providing a mixing chamber between the polyol source and the spraying device;
introducing a stream of polyol from the polyol source and a stream of colorant from the colorant source into the mixing device to form a stream of colorant/polyol;
introducing the stream of colorant/polyol and a stream of isocyanate from the isocyanate source into the spraying device to form a colored polyurethane composition; and
spraying the colored polyurethane composition onto a mold to form a first colored polyurethane skin.

2. The method of claim 1 further comprising providing a flush source, said method further comprising providing a stream of flushant from the flush source to the spraying device to flush the spraying device, and, after flushing the spraying device, providing a second stream of colorant/polyol and a second stream of isocyanate to the spraying device to form a second colored polyurethane skin.

3. The method of claim 2 wherein the second colored polyurethane skin is a different color than the first colored polyurethane skin.

4. The method of claim 2 wherein the second colored polyurethane skin is the same color as the first colored polyurethane skin.

5. The method of claim 2 wherein the at least one colorant source comprises a plurality of colorant sources.

6. The method of claim 2 wherein the colorant in the colorant/polyol stream comprises 1-20 wt. % colorant, based upon the total weight of the colorant/polyol stream.

7. The method of claim 2 further comprising a processor to selectively control the introduction of the colorant from the at least one colorant source into the mixing device.

8. The method of claim 5 further comprising a processor to selectively control the introduction of the colorant from the plurality of colorant sources into the mixing device.

9. The method of claim 2 further comprising providing a first colored layer on the mold prior to spraying the colored polyurethane composition onto the mold.

10. The method of claim 5 wherein the color of the first layer and the polyurethane skin are essentially the same.

11. A method of making polyurethane skins for interior components, said method comprising:
providing at least one liquid colorant source;
providing a polyol source;
providing an isocyanate source;
providing a spraying device;
introducing a stream of colorant from the colorant source into a stream of polyol from the polyol source to form a stream of colorant/polyol;
introducing the stream of colorant/polyol and a stream of isocyanate from the isocyanate source into the spraying device to form a colored polyurethane composition; and
spraying the colored polyurethane composition onto a mold to form a first colored polyurethane skin.

12. A system for manufacturing polyurethane skins for interior components, said system comprising:
a source of at least one liquid colorant;
a source of polyol;
a source of isocyanate;
a mixing chamber for mixing polyol with at least one colorant to form a colorant/polyol stream;
a spraying device for spraying a mixture of isocyanate and colorant/polyol; and
a mold having a mold surface toward which a mixture of isocyanate and colorant/polyol are sprayed by the spraying device onto the mold.

13. The system of claim 12 further comprising providing a flush source for providing a stream of flushant to flush the spraying device.

14. The system of claim 12 wherein the second colored polyurethane skin is a different color than the first colored polyurethane skin.

15. The system of claim 12 wherein the at least one colorant source comprises a plurality of individual colorant sources.

16. The system of claim 12 wherein the mixing device includes a helical mixing element.

17. The system of claim 12 wherein the colorant in the colorant/polyol stream comprises 1-20 wt. % colorant, based upon the total weight of the colorant/polyol stream.

18. The system of claim 12 further comprising a processor to selectively control the introduction of the colorant from the at least one colorant source into the mixing device.

19. The system of claim 15 further comprising a processor to selectively control the introduction of the colorant from the at least one colorant source into the mixing device.
